(19) United States
(12) Patent Application Publication
(10) Pub. No.: US 2025/0273651 A1
(43) Pub. Date: Aug. 28, 2025

(54) NEGATIVE ELECTRODE ACTIVE MATERIAL FOR LITHIUM SECONDARY BATTERY AND METHOD FOR PRODUCING SAME

(71) Applicants: Hyundai Motor Company, Seoul (KR); Kia Corporation, Seoul (KR); IUCF-HYU (Industry-University Cooperation Foundation Hanyang University), Seoul (KR)

(72) Inventors: Ki Kang Lee, Hwaseong (KR); Sung Ho Ban, Hwaseong (KR); Sang Hun Lee, Paju (KR); Chang Hoon Song, Seoul (KR); Tae Ho Park, Hwaseong (KR); Tae Rim Lee, Hwaseong (KR); Seung Tae Kim, Yongin (KR); Seung Min Oh, Incheon (KR); Eung Ju Lee, Daejeon (KR); Han Su Kim, Seoul (KR); Dong Han Youn, Namyangju (KR)

(21) Appl. No.: 18/801,223

(22) Filed: Aug. 12, 2024

(30) Foreign Application Priority Data
Feb. 27, 2024 (KR) 10-2024-0028285

(51) Int. Cl. H01M 4/36; C01B 33/32; H01M 4/02; H01M 4/38; H01M 4/48; H01M 4/58; H01M 10/0525

(52) U.S. Cl. CPC H01M 4/364; C01B 33/32; H01M 4/382; H01M 4/48; H01M 4/5825; H01M 10/0525; C01P 2002/54; C01P 2002/72; C01P 2002/74; C01P 2002/86; C01P 2006/40; H01M 2004/027; H01M 2220/20

(57) ABSTRACT

Provided is a lithium secondary battery negative electrode active material including a pre-lithiated silicon oxide-based complex containing Al, Li, and Si. More particularly, the present disclosure relates to a lithium secondary battery negative electrode active material and a production method thereof in which aluminum (Al) is additionally mixed and heat treated during pre-lithiation of a silicon oxide-based negative electrode active material, such as SiOₓ(0<x<2), to form compounds, such as Al₂O₃ and Li₂SiO₃, which have the effect of preventing the silicon oxide-based negative electrode active material from cracking, which occurs due to shrinkage and expansion of the silicon oxide-based negative electrode active material during charging and discharging of a battery.

### CROSS REFERENCE TO RELATED APPLICATION

The present application claims the benefit of Korean Patent Application No. 10-2024-0028285, filed on Feb. 27, 2024, the entire contents of which is incorporated herein for all purposes by this reference.

### BACKGROUND

### Technical Field

The present disclosure relates to a lithium secondary battery negative electrode active material including a pre-lithiated silicon oxide-based complex containing Al, Li, and Si. More particularly, the present disclosure relates to a lithium secondary battery negative electrode active material and a production method thereof in which aluminum (Al) is additionally mixed and heat treated during the pre-lithiation of a silicon oxide-based negative electrode active material, such as SiOₓ(0<x<2). This process forms compounds such as Al₂O₃ and Li₂SiO₃, which help prevent the cracking of the silicon oxide-based negative electrode active material caused by shrinkage and expansion during charging and discharging.

### Background

The recent surge in demand for electric vehicles, driven by environmental concerns, has led to significant increase in demand for high-energy density lithium secondary batteries, as energy density is directly related to battery performance improvements. Lithium rechargeable batteries are widely used as energy storage devices. In recent years, there has been a growing demand for high-energy density batteries to comply with global regulations, such as those on CO₂ and greenhouse gas emissions.

Graphite, commonly used as a negative electrode material for lithium secondary batteries, has a low theoretical capacity per weight of 372 mAh/g, limiting its potential for increasing energy density. Therefore, graphite cannot meet the high energy density requirements of electric vehicles, such as the driving range per charge, which needs to be overcome.

As a negative electrode active material that is emerging due to these needs, silicon is emerging as a promising attracting attention. It is regarded as a next-generation negative electrode active material due to its discharge capacity per weight, which is about 10 times higher than that of graphite at 3579 mAh/g. However, silicon has the disadvantage of poor lifetime characteristics due to particle cracking and electrode delamination caused by its high expansion rate of about 300% during silicon filling.

Silicon oxides SiOₓ(0<x<2) have garnered attention as one of the silicon-based negative electrode active materials. They offer a discharge capacity per weight that is about three times higher than that of graphite while exhibiting excellent lifetime characteristics compared to silicon. However, silicon oxides face the challenge of low initial efficiency due to irreversible reactions during the initial charging.

Since lithium consumed through irreversible reactions directly reduces the energy density in the full cell drive phase in which the total amount of lithium is fixed, the initial efficiency is reduced. Therefore, techniques to mitigate this is required.

As a way to increase the initial efficiency of these materials, research is actively being conducted on pre-lithiation techniques in which silicon oxide is reacted with other metals, such as Li, Mg, and Ca. However, silicon oxide-based compounds formed during pre-lithiation can slightly deteriorate lifetime characteristics.

The information disclosed in this Background of the present disclosure section is only for enhancement of understanding of the general background of the present disclosure may not be taken as an acknowledgement or any form of suggestion that this information forms the related art already known to a person skilled in the art.

### SUMMARY

The present disclosure has been made to solve the problems occurring in the related art and provides a lithium secondary battery negative electrode active material including a pre-lithiation silicon oxide-containing complex containing Al, Li, and Si. More particularly, the present disclosure provides a lithium secondary battery negative electrode active material and a production method thereof in which aluminum (Al) is additionally mixed and heat treated during pre-lithiation of a silicon oxide-based negative electrode active material, such as SiOₓ(0<x<2), to form a compound, such as AL₂O₃ and Li₂SiO₃which have the effect of preventing the silicon oxide-containing (or silicon oxide-based) negative electrode active material from cracking, which occurs due to shrinkage and expansion of the silicon oxide-containing negative electrode active material during charging and discharging.

The effects, features, and objectives of the present disclosure are not limited to the ones mentioned above, and other effects, features, and objectives not mentioned above can be clearly understood by those skilled in the art from the following description.

A lithium secondary battery negative electrode active material according to one embodiment of the present disclosure is characterized by the inclusion of a pre-lithiated silicon oxide-containing complex containing Al.

For example, the negative electrode active material may include at least one selected from Al, Al₂O₃, AlLiO₂, LiAlO₆Si₂, AlLiO₄Si, Li₂SiO₃, SiOₓ(0<x<2), and AlLiO₄Si.

For example, Al₂O₃ may be present in two phases: tetrahedral and octahedral.

For example, an X-ray diffraction angle (2θ) analysis using a Cu-Kα source may exhibit a first peak at an angle of 37.7° to 37.8°, a second peak at an angle of 22.2° to 22.3°, a third peak at an angle of 25.5° to 25.6°, a fourth peak at an angle of 25.2° to 25.3°, and a fifth peak at an angle of 26.9° to 27.0°.

For example, a ²⁷Al-MAS-NMR analysis may exhibit a first frequency at 9.5 ppm and a second frequency at 68 ppm.

For example, an Al content with respect to 100 wt % of the negative electrode active material may be in a range of 0.2 to 4 wt %.

A method of producing a negative electrode active material for a lithium secondary battery, according to one embodiment of the present disclosure to achieve the above objectives, includes: mixing Si, Li, and Al to form a mixture; and heat treating the Si, Li, and Al mixture to obtain the negative electrode active material comprising a pre-lithiated silicon complex.

For example, Si may be provided in the form of SiOₓ(0<x<2) powder, Li may be provided in the form of LiH powder, and Al may be provided in the form of Al powder.

For example, a weight ratio of the SiO powder to the Al powder may be in a range of about 5000:10 to 250. A weight ratio of the LiH powder to the Al powder may be in a range of about 600:10 to 250.

For example, Si, Li, and Al may be introduced into a container along with zirconia balls for the mixing.

For example, a mixing time may be in a range of from about 20 to 40 minutes.

For example, a mixing speed may be in a range of rom about 400 to 600 RPM.

For example, the method may further include stabilizing the mixture after the mixing of Si, Li and Al.

For example, the heat treating may be performed under an Ar atmosphere.

For example, the heat treating may be performed at a temperature of about 700° C. to 800° C. for a duration of about 5 to 7 hours.

For example, the method may further include cooling the heat-treated mixture after the heat treating.

A lithium secondary battery negative electrode according to the present disclosure includes the lithium secondary battery negative electrode active material of the present disclosure.

A lithium secondary battery according to the present disclosure includes the lithium secondary battery negative electrode active material of the present disclosure.

Also provided is a vehicle comprising the lithium secondary battery.

The present disclosure relates to a lithium secondary battery negative electrode active material including a pre-lithiated silicon oxide-based complex containing Al, Li, and Si. More particularly, the present disclosure relates to a lithium secondary battery negative electrode active material and a production method thereof in which aluminum (Al) is additionally mixed and heat treated during pre-lithiation of a silicon oxide-based negative electrode active material, such as SiOₓ(0<x<2), to form compounds, such as Al₂O₃ and Li₂SiO₃, which have the effect of preventing the silicon oxide-based negative electrode active material from cracking, which occurs due to shrinkage and expansion of the silicon oxide-based negative electrode active material during charging and discharging.

The term pre-lithiation or pre-lithiated as referred to herein indicates lithium added to an anode component prior to cell assembly, Other sources of lithium include those of the cathode. In aspects, a higher reversible lithium capacity for an anode can be achieved by the phased introduction of lithium by pre-lithiation, cell forming, aging the cell, and subsequent introduction of lithium from the cathode by the charging (e.g. full voltage) charging step.

The effects and advantages that can be achieved by the present disclosure are not limited to the ones mentioned above, and other effects and advantages which are not mentioned above but can be achieved by the present disclosure can be clearly understood by those skilled in the art from the following description.

### BRIEF DESCRIPTION OF THE DRAWINGS

FIG. 1 is a flowchart illustrating a method of producing a lithium secondary battery negative electrode active as one embodiment of the present disclosure;

FIG. 2 is a graph showing the results of X-ray diffraction analysis for the examples of the present disclosure and comparative examples;

FIG. 3 is a diagram showing the results of ²⁷Al-MAS-NMR measurement for the materials of the examples and comparative examples of the present disclosure;

FIG. 4 is a graph showing the initial charge capacity and initial discharge capacity of a lithium secondary battery for the cases of using the materials of the examples and comparative examples of the present disclosure;

FIG. 5 is a graph showing the initial efficiency of a lithium secondary battery for the cases of using the materials of the examples and comparative examples of the present disclosure;

FIG. 6 is a graph showing the capacity of a lithium secondary battery over charge and discharge cycles for the cases of using the materials of the examples and comparative examples of the present disclosure; and

FIG. 7 is a graph showing the capacity retention over charge and discharge cycles of a lithium secondary battery for the cases of using the materials of the examples and comparative examples of the present disclosure.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment. In the figures, reference numbers refer to the same or equivalent parts of the present invention throughout the several figures of the drawing.

### DETAILED DESCRIPTION

The present disclosure may be embodied in many forms and have various embodiments. Thus, specific embodiments will be illustrated in the accompanying drawings and described in detail below. While specific embodiments of the disclosure will be described herein below, they are only illustrative purposes and should not be construed as limiting to the present disclosure. Accordingly, the present disclosure should be construed to cover not only the specific embodiments but also cover all modifications, equivalents, and substitutions that fall within the sprit and technical scope of the present disclosure.

The terminology used herein is for the purpose of describing particular embodiments only and is not intended to limit the scope of the present disclosure. As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof.

Herein, when referring to a range of “X to Y”, it shall be construed to include not only X and Y but also all numbers between X and Y. For example, a range of 1 to 10 should be interpreted as including not only 1 and 10, but also the numbers in between, i.e., both whole numbers and decimals.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

As used herein the term “pre-lithiated” means the chemical or electrochemical deposition or absorption of lithium into a lithium containing electrochemically active material for use as an electrode for an electrochemical cell such as a lithium-ion cell, or electrode including a lithium containing electrochemically active material such that the lithium content of the active material or electrode including an active material is increased relative to the lithium content of the as-synthesized active material or electrode formed with the as-synthesized active material. The term “pre-lithiated” excludes lithium, lithium salts, lithium oxides, lithium hydroxides or lithium peroxides sintered, mixed, or high-energy milled with a transition metal compound, or oxides, hydroxides or salts of a transition metal compound. The term “pre-lithiated” excludes lithium, lithium salts, lithium oxides, lithium hydroxides or lithium peroxides sintered, mixed, or high-energy milled with a positive electrode active material for an electrochemical cell, more specifically for a lithium-ion cell.

In addition, unless otherwise defined, all terms including technical and scientific terms used herein have the same meaning as commonly understood by those who are ordinarily skilled in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

X-ray diffraction (XRD) is a non-destructive technique for obtaining detailed phase and structural information from material samples. By measuring the diffraction angle of a primary X-ray beam according to Bragg's law, XRD can characterize and identify various chemicals, phases, and structures within a sample. The analysis method is particularly effective in determining the structure of polycrystalline materials. For the analysis, the EQUINOX 100 Diffractometer manufactured by Thermo Fisher Scientific Inc. may be used, or any other instrument used in the industry may be used as appropriate.

²⁷Al MAS-NMR spectroscopy is characterized by the ability to analyze local changes in crystal structure even when the crystal structure cannot be analyzed by XRD diffraction due to severe deformation. The method may be used to measure the distribution of aluminum in a sample. For the measurement, the Bruker AVANCE III 600 WB spectrometer may be used, or any other instrument known in the art may be used as appropriate.

Typically, electrodes with a pre-lithiated silicon negative electrode active material exhibit reduced capacity retention compared to electrodes with a silicon negative electrode active material (SiO) that is not pre-lithiated. The pre-lithiated silicon negative electrode active material forms Li₄SiO₄ as the final phase, which may degrade when exposed to air.

However, the present disclosure provides a lithium secondary battery negative electrode active material having the effect of improved initial efficiency and preventing particle cracking, and a production method thereof. When producing the negative electrode active material, aluminum is additionally mixed during the pre-lithiation of a silicon-based negative electrode active material “SiOₓ(0<x<2)”, and the mixture is subjected to dry heat treatment to form Al₂O₃ or Li₂SiO₃. That is, a silicon oxide-based complex containing Si, Si, Li₂SiO₃, Al, Al₂O₃, and AlLiO₂ phases is formed. The complex can improve the initial efficiency through an irreversible phase generation reaction by not reacting with lithium. In addition, aluminum (Al) contained in the negative electrode active material has the effect of preventing particle crushing that occurs due to shrinkage and expansion of the silicon-based negative electrode active material during charging and discharging.

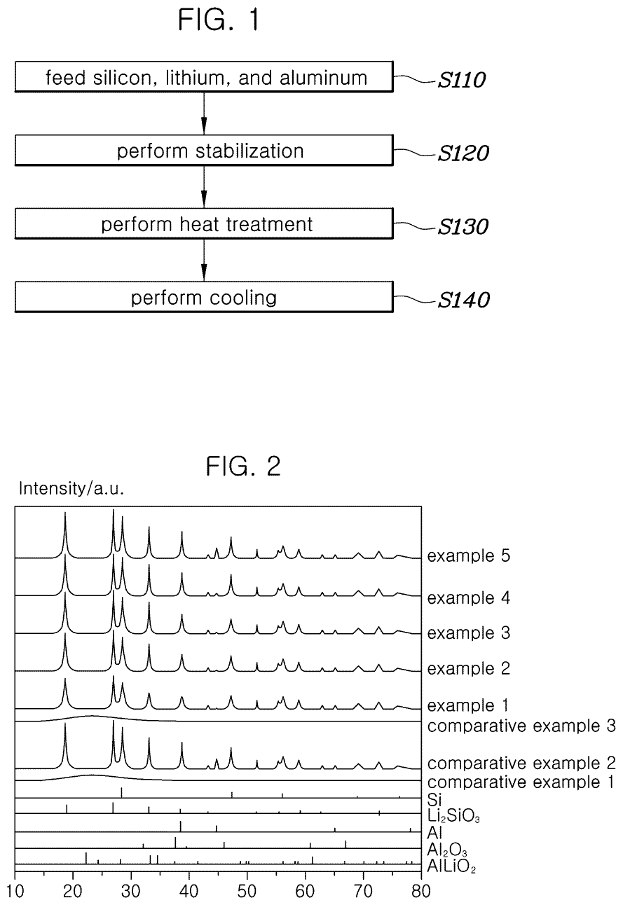

FIG. 1 is a flowchart illustrating a method of producing a lithium secondary battery negative electrode active as one embodiment of the present disclosure. Referring to FIG. 1, a method for producing a negative electrode active material for lithium secondary batteries, according to one embodiment of the present disclosure, will be described.

First, a mixing step of mixing Si, Li, and Al is performed (S110).

Typically, electrodes with a pre-lithiated silicon negative electrode active material show reduced capacity retention compared to electrodes with a silicon negative electrode active material (SiO) that is not pre-lithiated. The pre-lithiated silicon negative electrode active material forms Li₄SiO₄ as the final phase, which may be degrade when exposed to air.

However, by the lithium secondary battery negative electrode active material production method, it is possible to produce a lithium secondary battery negative electrode active material containing a pre-lithiated silicon oxide-based complex containing Al, Li, and Si. Specifically, compounds of Si phases, Al-based phases, such as Al₂O₃, and Li-based phases, such as Li₂SiO₃ can be formed. Compounds, such as Al₂O₃ and Li₂SiO₃, which are less likely to degrade when exposed to air, are formed, thereby preventing the silicon-based negative electrode active material powder from cracking that may occur due to shrinkage and expansion of the powder particles during charging and discharging of the battery, and enabling the battery to have excellent initial charge capacity, initial discharge capacity, initial efficiency, and capacity retention.

Here, the silicon-based negative electrode active material may be a silicon oxide-based complex “SiOₓ(0<x<2)”.

On the other hand, the mixing step of mixing Si, Li, and Al may be a step of mixing SiO powder, LiH powder, and Al powder.

The weight ratio of the SiO powder to Al powder to be mixed may be 5000:10 to 250, and the weight ratio of the LiH powder to Al powder may be 600:10 to 250. Specifically, 0.014 to 0.204 g of Al may be mixed with respect to 5 g of SiO and 0.601 g of LiH as will be confirmed from the examples described below.

When the mixing ratio of Al is within the mentioned range, the silicon-based negative electrode active material may not be well pre-lithiated, so that the effect of pre-lithiation, i.e., increase in initial charge efficiency, may be minimal. Moreover, the formation of Al₂O₃ and compounds such as Li₂SiO₃, which are less likely to degrade when exposed to air, is reduced, so that the effect of preventing the silicon-based negative electrode active material powder from cracking due to shrinkage and expansion during charging and discharging is reduced. When the mixing ratio of Al exceeds the specified range, the excess Al powder causes the Si phase to coarsen, making it difficult to accommodate the expansion and shrinkage of the Si phase during charging and discharging. This, in turn, reduces the effectiveness of preventing the silicon-based negative electrode active material powder from cracking.

Furthermore, as will be understood with reference to the examples described below, when the lithium secondary battery negative electrode active material satisfying the mentioned mixing range has an excellent effect of preventing the negative electrode active material from cracking even though the negative electrode active material shrinks and expands during charging and discharging, and has excellent initial charge capacity, initial discharge capacity, initial efficiency, and capacity retention rate.

The SiO powder, LiH powder, and Al powder may be placed with zirconia balls in a container together for mixing. The zirconia balls aid chemical reactions among the SiO powder, the LiH powder, and the Al powder as well as the physical mixing.

When mixing the SiO powder, the LiH powder, and the Al powder, the mixing time may be in a range of 20 to 40 minutes and the mixing speed may be in a range of 400 to 600 RPM. These conditions are determined for the effective mixing of the SiO powder, the LiH powder, and the Al powder.

Specifically, with a paint shaker with a container volume of 30 ml, the powders may be mixed at a mixing speed of 500 rpm for a mixing time of 30 minutes.

After the mixing, the mixture containing Si, Li, and Al may be stabilized at room temperature (25° C.) (S120).

This stabilization enables the mixed powder to be effectively treated in the subsequent heat treatment step.

The stabilization step is performed at room temperature (25° C.) for 20 to 40 minutes. Specifically, the stabilization step may be carried out under an Ar atmosphere at room temperature (25° C.) for 30minutes.

Next, a step of heat treating the mixture of Si, Li, and Al is performed (S130).

The heat treatment step may be performed in an alumina container.

For example, the heat treatment may be performed in a container such as alumina crucible (purity: 99.5% to 99.8%, volume: 100 ml).

In addition, the heat treatment step is performed at 700° C. to 800° C. for 5 to 7 hours.

It is because the lithium secondary battery negative electrode active material, which satisfies the above-mentioned heat treatment conditions, exhibits an excellent effect of preventing the negative electrode active material from cracking when the negative electrode active material shrinks and expands during charging and discharging. Additionally, it demonstrates excellent initial charge capacity, initial discharge capacity, initial efficiency, and capacity retention rate.

Specifically, under an Ar atmosphere, the temperature may be raised from room temperature (25° C.) to 750° C. at a rise rate of 10° C./min and maintained at 750° C. for 6 hours.

Next, a cooling step may then be performed to cool the heat-treated mixture (S140).

In this step, the mixture may be cooled down to room temperature (25° C.), and the cooling rate may be 5 to 15° C./min. In this step, the cooling rate of the mixed powder having a high temperature state due to the heat treatment is controlled, so that the effect of preventing the lithium secondary battery negative electrode active material from cracking due to shrinkage and expansion during charging and discharging of a battery, initial charge capacity, initial discharge capacity, initial efficiency, and capacity retention rate can be increased.

Specifically, the cooling may be performed so that the mixture is cooled down from 750° C. to room temperature (25° C.) at a rate of 10° C./min under an Ar atmosphere.

Hereinafter, a negative electrode active material for lithium secondary batteries, according to one embodiment of the present disclosure, will be described.

The lithium secondary battery negative electrode active material of the present disclosure is characterized by the inclusion of a pre-lithiated silicon oxide-based complex containing Al, Li. This complex has the ability to accommodate stresses caused by rapid changes in the volume of the silicon oxide-based complex during charging and discharging.

As described above, typically, electrodes with a pre-lithiated silicon negative electrode active material show a reduced capacity retention compared to electrodes with a silicon negative electrode active material (SiO) which is not pre-lithiated, and the pre-lithiated silicon negative electrode active material forms Li₄SiO₄ as the final phase, which may degrade when exposed to air.

However, when Al is added to a negative electrode active material like the lithium secondary battery negative electrode active material of the present disclosure, Al₂O₃ and compounds such as Li₂SiO₃, which are less likely to degrade when exposed to air, are formed during a pre-lithiation process. The compounds can prevent the silicon-based negative electrode active material powder from cracking attributable to shrinkage and expansion of the powder particles during charging and discharging of the battery, and increase initial charge capacity, initial discharge capacity, initial efficiency, and capacity retention.

Here, the silicon-based negative electrode active material may be a silicon oxide-based complex “SiOₓ(0<x<2)”.

The lithium secondary battery negative electrode active material of the present disclosure which is characterized by the inclusion of a pre-lithiated silicon oxide-based complex containing Al, Li, and Si may contain lithium silicate (Li₂SiO₃), aluminum (Al), alumina (Al₂O₃), Si, AlLiO₂, etc.

Al may be contained in the form of Al₂O₃, AlLiO₂, LiAlO₆Si₂, or AlLiO₄Si, and Al₂O₃ may be present as two phases, tetrahedral and octahedral.

Si may be contained in the form of SiOₓ(0<x<2), LiAlO6Si2, AlLiO₄Si, or Li₂SiO₃.

Li can be contained in the form of Li₂SiO₃, SiOₓ(0<x<2), LiAlO₆Si₂, or AlLiO₄Si.

The results of X-ray diffraction angle (2θ) analysis using a Cu-Kα source of the lithium secondary battery negative electrode active material of the present disclosure show a first peak at an angle of 37.7° to 37.8°, a second peak at an angle of 22.2° to 22.3°, a third peak at an angle of 25.5° to 25.6°, a fourth peak at an angle of 25.2° to 25.3°, and a fifth peak at an angle of 26.9° to 27.0°.

In addition, the results of ²⁷Al-MAS-NMR analysis exhibit a first frequency at 9.5 ppm and a second frequency at 68 ppm.

The weight ratio of SiO and Al in the negative electrode active material for the lithium secondary battery of the present disclosure may be in a range of 5000:10 to 250, and the weight ratio of LiH and Al may be in a range of 600:10 to 250. Specifically, 0.014 to 0.204 g of Al may be mixed with 5 g of SiO and 0.601 g of LiH, as will be confirmed from the examples described below.

When the mixing ratio of Al is within the mentioned range, the silicon-based negative electrode active material may not be well pre-lithiated, so that the effect of pre-lithiation, i.e., increase in initial charge efficiency, may be minimal. Moreover, the formation of Al₂O₃ and compounds such as Li₂SiO₃, which are less likely to degrade when exposed to air, is reduced, so that the effect of preventing the silicon-based negative electrode active material powder from cracking due to shrinkage and expansion during charging and discharging is reduced. In addition, when the mixing ratio of Al is exceeds the specified range, the excess Al powder causes the Si phase to coarsen, making it difficult to accommodate the expansion and shrinkage of the Si phase during charging and discharging, thereby reducing the effect of preventing the silicon-based negative electrode active material powder from cracking.

A lithium secondary battery negative electrode and a lithium secondary battery according to embodiments of the present disclosure may contain the negative electrode active material of the present disclosure.

Hereinafter, preferred examples are presented to help the understanding of the present disclosure. The following examples are only illustrative of the present disclosure, and the scope of the present disclosure is not limited by the examples.

### EXAMPLE AND COMPARATIVE EXAMPLES

### <Preparation of Negative Electrode Active Material>

### Example 1

5 g of SiO powder, 0.601 g of LiH powder, and 0.014 g of Al powder were placed in an airtight container with zirconia balls (50 g) and mixed evenly. For the mixing, the paint shaker was used. (Container volume: 30 ml, mixing time: 30 min, speed: 500 rpm)

The powder obtained was then loaded into an alumina crucible. The Alumina crucible had a purity of 99.8% and a volume of 100 ml.

Next, heat treatment was performed to complete the preparation of a powder.

The heat treatment was performed as follows: the mixed powder was rested at room temperature (25° C.) under an Ar atmosphere for 30 minutes, then heated to 750° C. at a rise rate of 10° C./min, and maintained at 750° C. for 6 hours. Next, the mixed power was cooled down to room temperature (25° C.) at a rate of 10° C./min to obtain a negative electrode active material.

### Example 2

A negative electrode active material was prepared by heat treating a mixed powder under the same conditions, except that the mixed power is composed of 5 g of SiO powder, 0.601 g of LiH, and 0.025 g of Al.

### Example 3

A negative electrode active material was prepared by heat treating a mixed powder under the same conditions, except that the mixed power is composed of 5 g of SiO powder, 0.601 g of LiH, and 0.051 g of Al.

### Example 4

A negative electrode active material was prepared by heat treating a mixed powder under the same conditions, except that the mixed power is composed of 5 g of SiO powder, 0.601 g of LiH, and 0.102 g of Al.

### Example 5

A negative electrode active material was prepared by heat treating a mixed powder under the same conditions, except that the mixed power is composed of 5 g of SiO powder, 0.601 g of LiH, and 0.204 g of Al.

### Comparative Example 1

A negative electrode active material was prepared without adding Al and LiH to 5 g of SiO powder and without any heat treatment.

### Comparative Example 2

A negative electrode active material was prepared by heat treating a mixed powder under the same conditions, except that the mixed power is composed of 5 g of SiO powder, 0.601 g of LiH, and 0.0 g of Al (i.e., Al was not added).

### Comparative Example 3

A negative electrode active material was prepared by heat treating a mixed powder under the same conditions, except that the mixed power is composed of 5 g of SiO powder, 0.0 g of LiH (i.e., LiH was not added), and 0.51 g of Al.

The amounts of SiO, LiH, and Al powders added in Examples 1 to 3 and Comparative Examples 1 to 5 are summarized in Table 1 below.

TABLE 1

| | SiO (g) | LiH (g) | Al (g) |
|---|---|---|---|
| Comparative | 5 | — | — |
| Example 1 | | | |
| Comparative | 5 | 0.601 | — |
| Example 2 | | | |
| Comparative | 5 | — | 0.51 |
| Example 3 | | | |
| Example 1 | 5 | 0.601 | 0.014 |
| Example 2 | 5 | 0.601 | 0.025 |
| Example 3 | 5 | 0.601 | 0.051 |
| Example 4 | 5 | 0.601 | 0.102 |
| Example 5 | 5 | 0.601 | 0.204 |

### Experimental Example

### <X-Ray Diffraction Analysis>

The negative electrode active materials of Examples 1 through 5 and Comparative Examples 1 through 3 were subjected to X-ray diffraction analysis. The results are shown in FIG. 2.

The analysis results of Examples 1 through 5 in which SiO, LiH, and Al are added show a peak by Al₂O₃ at an angle of 37.7° to 37.8°, a peak by AlLiO2 at an angle of 22.2° to 22.3°, a peak by LiAlO₆Si₂ at an angle of 25.5° to 25.6°, a peak by AlLiO4Si at an angle of 25.2° to 25.3°, and a peak by Li₂Si₂O₃ at an angle of 26.9° to 27.0°. The results confirm that Examples 1 through 5 contain the materials.

### <²⁷Al-MAS-NMR Analysis>

The negative electrode active materials of Examples 1 through 5 and Comparative Examples 1 through 3 were subjected to ²⁷Al-MAS-NMR analysis.

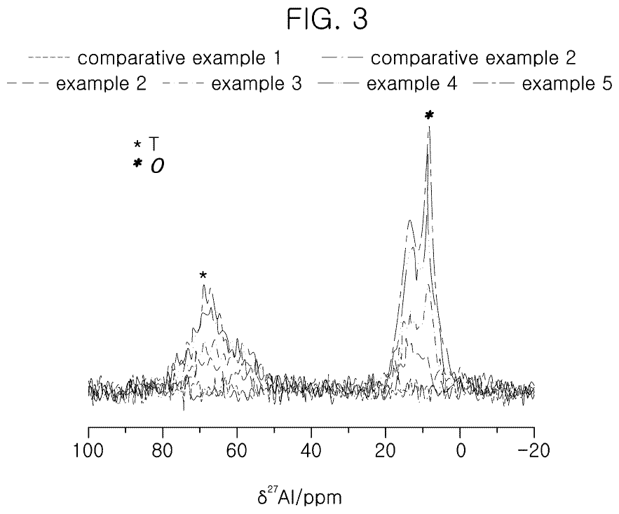

The results of this analysis are shown in FIG. 3. In FIG. 3, T indicates 68 ppm, which is the frequency of the tetrahedral phase of Al₂O₃, and O indicates 9.5 ppm, which is the frequency of the octahedral phase of Al₂O₃.

In the case of Examples 2 through 5, except for Comparative Examples 1 and 2, a frequency of 68 ppm for the tetrahedral phase of Al₂O₃ and a frequency of 9.5 ppm for the octahedral phase of Al₂O₃ were observed. It can be seen that the intensity of the frequencies increases as the amount of Al added increases.

From the results, it can be confirmed that the Al₂O₃ tetrahedral phase and the Al₂O₃ octahedral phase were formed in Examples 2 to 5 in which Al was added and that the peak intensity of the Al₂O₃tetrahedral phase and the peak intensity of the Al₂O₃ octahedral phase increased as the amount of Al addition increased.

### <Electrochemical Evaluation>

Electrochemical evaluations were performed on the materials of the examples and comparative examples.

The negative electrode active material of the examples and comparative examples, Super-P as a conductive material, and PAA as a binder were mixed with DI water in a mass ratio of 8:1:1 to prepare a slurry composition. The slurry composition was applied onto copper foil and vacuum-dried at 120° C. for 2 hours to prepare a negative electrode.

A coin cell was assembled with the negative electrode, a lithium metal electrode as a positive electrode, and a polyethylene separator between the negative and positive electrodes, and an electrolyte composed of a mixture of 1 M LiPF₆ EC: EMC: DEC (2:2:5) and 10 wt % FEC.

The assembled coin cell was allowed to rest for 12 hours at room temperature, followed by charging and discharging.

(2) Formation stage

The manufactured half cells underwent two-step formation at room temperature (25° C.).

First step: Constant current charging at a current of 0.05C were performed until the voltage reached 0.01 V (vs. Li+/Li), followed by constant current discharging at 0.05C until the voltage reached 1.5 V (vs. Li+/Li).

Second step: in constant voltage mode, the cell was cut off at a current of 0.01 C and charged with a voltage of 0.01 V (vs. Li+/Li) maintained, and then discharged at a constant current of 0.05 C until the voltage reached 1.5 V (vs. Li+/Li).

(3) Measurement of initial efficiency measurement and measurement of capacity retention rate

After the formation stage, the cell was charged at a constant current of 0.5 C at room temperature (25° C.) until the voltage reached 0.01 V (vs. Li+/Li), and then constant current charging was performed in constant voltage mode while maintaining 0.01 V (vs. Li+/Li) by cutting off at a current of 0.01 C. After that, the cell was discharged at a constant current of 0.05 C until the voltage reached to 1.5 V (vs. Li+/Li). This cycle of charging and discharging was performed for 100 cycles.

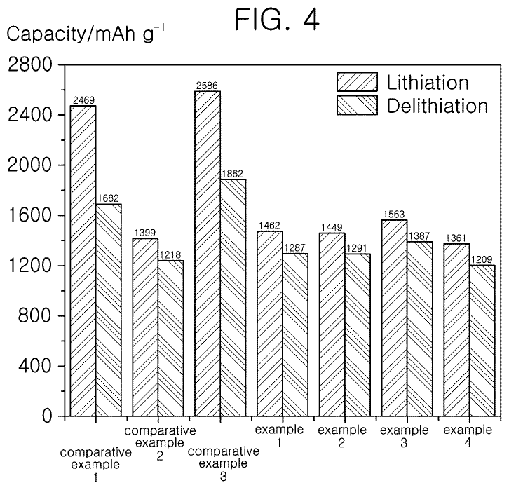

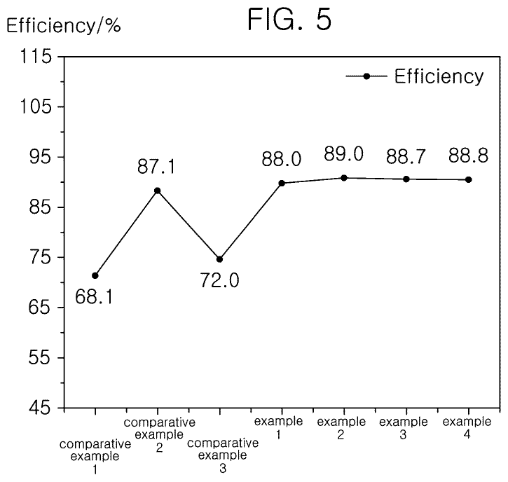

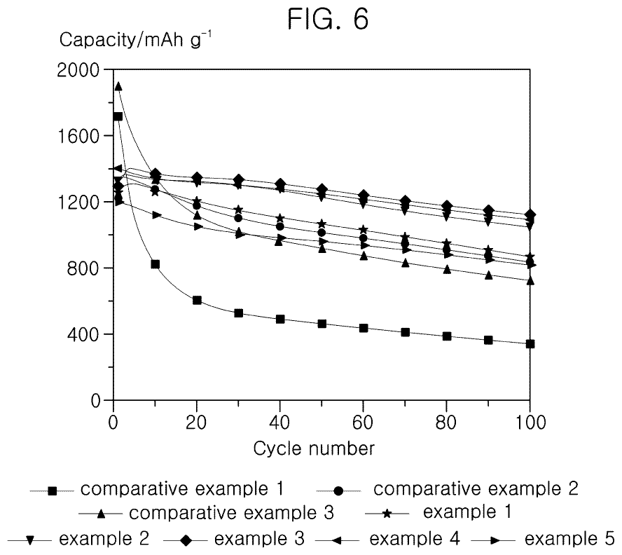

The Initial efficiency of each of the lithium secondary batteries using the materials of Examples 1 to 4 and Comparative Examples 1 and 3 was calculated using Equation 1 below, and the capacity retention rate was calculated using Equation 2. The initial charge capacity and initial discharge capacity (lithiation-delithiation) of Examples 1 to 4 and Comparative Examples 1 to 3 are shown in FIG. 4, and the initial charge efficiency is shown in FIG. 5. The data of FIG. 4 and FIG. 5 is summarized in Table 2 below.

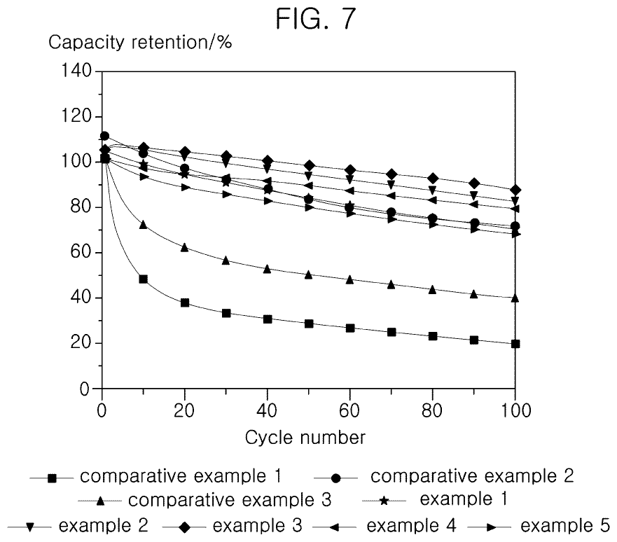

The capacity as a function of the number of charge/discharge cycles is shown in FIG. 6, and the capacity retention rate as a function of the number of charge/discharge cycles is shown in FIG. 7.

$$Initial efficiency ( \% ) = [ initial discharge capacity / initial charge capacity ] \times 100 ( \% ) \qquad [ Equation 1 ]$$

$$Capacity retention rate ( \% ) = [ discharge capacity at the current cycle / initial charge capacity ] \times 100 ( \% ) \qquad [ Equation 2 ]$$

TABLE 2

| | | Initial | |
|---|---|---|---|
| | Initial charge | discharge | |
| | capacity | capacity | Initial |
| | (mmAh/g) | (mmAh/g) | efficiency (%) |
| Comparative Example 1 | 2469 | 1682 | 68.1 |
| Comparative Example 2 | 1399 | 1218 | 87.1 |
| Comparative Example 3 | 2586 | 1862 | 72.0 |
| Example 1 | 1462 | 1287 | 88.0 |
| Example 2 | 1449 | 1291 | 89.0 |
| Example 3 | 1563 | 1387 | 88.7 |
| Example 4 | 1361 | 1209 | 88.8 |

Referring to FIG. 4 and FIG. 5 and Table 2, it can be seen that Comparative Example 1 with neither LiH nor Al and Comparative Example 3 without LiH have lower initial efficiency values compared to Comparative Example 2 and Examples 1 to 4 in which LiH was used. This confirms that the addition of LiH to SiO and pre-lithiation effectively increases the initial efficiency of the negative electrode active material.

Referring to FIG. 6, it can be seen that Comparative Example 1, which contains neither LiH nor Al, and Comparative Example 3, which lacks LiH, show a sharp decrease in discharge capacity with an increase in the number of charge and discharge cycles compared to Examples 1 to 5, which include both LiH and Al added. In particular, it can be seen that Comparative Example 1, which contains neither LiH nor Al, show a rapid decrease in discharge capacity with an increase in the number of charge and discharge cycles compared to Comparative Example 3, which lacks LiH but with Al. This confirms that the addition of LiH and Al to SiO is effective in preventing the discharge capacity from decreasing with an increase in the number of charge and discharge cycles.

Referring to FIG. 7, it can be seen that Comparative Example 1, which contains neither LiH nor Al, and Comparative Example 3, which lacks LiH, show a sharp decrease in capacity retention, i.e., lifetime characteristics, with an increase in the number of charge and discharge cycles compared to Examples 1 to 5 with both LiH and Al added. In particular, it can be seen that Comparative Example 1, which contains neither LiH nor Al, show a rapid decrease in capacity retention with an increase in the number of charge and discharge cycles compared to Comparative Example 3 without LiH but with Al. This confirms that the addition of LiH and Al to SiO is effective in improving the capacity retention, i.e., lifetime characteristics with an increase in the number of charge and discharge cycles.

In other words, the silicon-based negative electrode active material “SiOₓ(0<x<2)” added with LiH and Al has a high initial efficiency through pre-lithiation, and has the effect of preventing particle cracking when the silicon-based negative electrode active material shrinks and expands during charging and discharging by the addition of an Al-based material, which is effective for lifetime characteristics.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. A negative electrode active material for lithium secondary batteries, the negative electrode active material comprising a pre-lithiated silicon oxide containing complex containing Al.

2. The negative electrode active material of claim 1, comprising at least one selected from Al, Al₂O₃, Li₂SiO₃, AlLiO₂, LiAlO₆Si₂, AlLiO₄Si, and SiOₓ(0<x<2) compounds.

3. The negative electrode active material of claim 2, wherein the Al₂O₃ exists in two phases: tetrahedral and octahedral.

4. The negative electrode active material of claim 1, wherein an X-ray diffraction angle (2θ) analysis using a Cu-Kα source exhibits a first peak at an angle of 37.7° to 37.8°, a second peak at an angle of 22.2° to 22.3°, a third peak at an angle of 25.5° to 25.6°, a fourth peak at an angle of 25.2° to 25.3°, and a fifth peak at an angle of 26.9° to 27.0°.

5. The negative electrode active material of claim 1, a ²⁷Al-MAS-NMR analysis exhibits a first frequency at 9.5 ppm and a second frequency at 68 ppm.

6. A method of producing a negative electrode active material for lithium second batteries, the method comprising:
mixing Si, Li, and Al to form a mixture; and
heat-treating the mixture to obtain the negative electrode active material comprising a pre-lithiated silicon complex.

7. The method of claim 6, wherein the Si is SiOₓ(0<x<2) powder, the Li is LiH powder, and the Al is Al powder.

8. The method of claim 7, wherein a weight ratio of the SiO powder to the Al powder is in a range of about 5000:10 to 250.

9. The method of claim 7, wherein a weight ratio of the LiH powder to the Al powder is in a range of about 600:10 to 250.

10. The method of claim 6, wherein in the mixing, zirconia balls are mixed with the Si, Li and Al together in a container.

11. The method of claim 10, wherein a mixing time for the mixing is in a range of about 20 to 40 minutes.

12. The method of claim 10, wherein a mixing speed for the mixing is in a range of about 400 to 600 rpm.

13. The method of claim 6, further comprising stabilizing the mixture at room temperature after the mixing.

14. The method of claim 6, wherein the heat-treating is performed under an Ar atmosphere.

15. The method of claim 6, wherein the heat-treating is performed at a temperature in a range of about 700° C. to 800° C.

16. The method of claim 6, wherein the heat-treating is performed for about 5 to 7 hours.

17. The method of claim 6, further comprising cooling the heat-treated mixture after the heat-treating.

18. An electrode for a lithium secondary battery, the electrode comprising the negative electrode active material of claim 1.

19. A lithium secondary battery comprising the negative electrode active material of claim 1.

20. A vehicle comprising the lithium secondary battery of claim 19.
